(19) United States
(12) Patent Application Publication
(10) Pub. No.: US 2009/0207134 A1
(43) Pub. Date: Aug. 20, 2009

(54) REMOTE CONTROL APPARATUS WITH INTEGRATED POSITIONAL RESPONSIVE ALPHABETIC KEYBOARD

(75) Inventor: Michael Spilo, Greenwich, CT (US)

Correspondence Address: DARBY & DARBY P.C., P.O. BOX 770, Church Street Station, New York, NY, 10008-0770, US

(73) Assignee: Netgear Inc., Santa Clara, CA (US)

(21) Appl. No.: 12/031,455

(22) Filed: Feb. 14, 2008

(51) Int. Cl. G06F 3/033

(52) U.S. Cl. 345/158

(57) ABSTRACT

In accordance with one embodiment, a remote control apparatus includes a first transmission means for use when the remote control apparatus is in a horizontal orientation and a second transmission means for use when the remote control apparatus is in a vertical orientation. The remote control apparatus further includes a keypad having a plurality of keys that have a first set of labels for use in the horizontal orientation and a second set of labels for use in the vertical orientation. In addition, a means for determining whether the remote control is in the horizontal orientation or the vertical orientation is provided as part of the remote control apparatus. At least some of the keys have a first functionality when in the horizontal orientation and a second functionality when in the vertical orientation.

### TECHNICAL FIELD

The present invention is directed to a remote control apparatus with a keypad, and in particular, to a remote control apparatus with a positional responsive alphabetic keyboard which alters the function of the keypad according to the physical orientation of the remote control.

### BACKGROUND

Remote control technology has evolved so that full keypads as well as mice are available as “remote” interface devices. These standard keyboards and mice are detachable and can be used remotely using radio frequency (RF) or infrared (IR) communications between the remote control device and the computer.

However, the large form factor and number of keys required for a full keyboard makes typical keyboards unwieldy for use in a TV viewing environment. Several solutions have been proposed for this problem, the most common being a separate remote and keyboard combination. However, this requires additional space and with the number of remotes that a typical user has for all the electronic components of the entertainment center, the expansion of a remote to contain such combination is not an attractive proposition. Other solutions involve a clamshell design or a slide out design in which two separate keyboards are combined mechanically. Common examples of this design can be found in cell phones from a variety of manufacturers. The main drawback of this approach is the cost involved with either the mechanical solution or the use of dual keyboards; however, this type of approach and design does offer an ergonomic advantage.

Other solutions to the problem involve using complex software to determine what key the user is actually pressing by requiring the user to press the keys multiple times or by interpreting the combination of keys based on some algorithm that is part of the software. Examples of this type of technology are “multitap” in which a user presses “2” for the letter “a” and presses “22” for the letter “b” and so on. Another method is that of attempting to discern the user's meaning based on a combination of keys. On example of this type of method is commonly referred to as “T9”. The drawbacks of these solutions are that they are slow for text entry and require a substantial learning curve from the user. Other solutions involve touch screens to resolve this issue and in this case, the device is designed so that the touch screens alternately display a keyboard or a control pad. Unfortunately, these systems are even more costly than the multiple keyboard mechanical solutions and are also prone to typing errors.

For TV or computer based devices, another method involves displaying a keyboard on the screen and allowing the user to navigate the keyboard with directional arrows. The drawback of this approach is the slow speed of data entry.

FIG. 1 shows a conventional remote control 10 for use with a media device, such as a television, etc. The remote control 10 includes groupings of keys for numeric channel entry, shuttle playback control and additional function specific keys, such as keys for menu navigation. This type of remote control 10 does not have an alphabetic keyboard and therefore, does not offer this type of functionality.

### SUMMARY

A remote control apparatus according to one embodiment includes a keypad having a plurality of keys that have a first set of labels for use when the remote control is in a horizontal orientation and a second set of labels for use when the remote control is in a vertical orientation. The remote control also has a means for determining whether the remote control is in the horizontal orientation or the vertical orientation. At least some of the keys have a dual use in that the first label of one key corresponds to a first functionality that is realized by actuating the key when the remote control is operating in a horizontal orientation mode and the second label for the same key corresponds to a second functionality that is realized by actuating the key when the remote control is operating in a vertical orientation mode.

In accordance with one embodiment, a remote control apparatus includes a first transmission means for use when the remote control apparatus is in a horizontal orientation and a second transmission means for use when the remote control apparatus is in a vertical orientation. The remote control apparatus further includes a keypad having a plurality of keys that have a first set of labels for use in the horizontal orientation and a second set of labels for use in the vertical orientation. In addition, a means for determining whether the remote control is in the horizontal orientation or the vertical orientation is provided as part of the remote control apparatus. At least some of the keys have a first functionality when in the horizontal orientation and a second functionality when in the vertical orientation.

In this manner, an alphabetic keyboard can be incorporated into a simple remote control device in order to provide full alphanumeric text entry as well as remote control functionality. The remote control keys have a dual use as either a keyboard or standard remote and in one embodiment, the key's purpose is changed automatically (e.g., by use of a tilt sensor) or manually (e.g., by use of a switch). The remote control apparatus can emit a different set of codes depending upon the orientation thereof or it can emit the same set of codes.

### BRIEF DESCRIPTION OF THE DRAWING FIGURES

FIG. 1 is front elevation view of a conventional remote control apparatus;

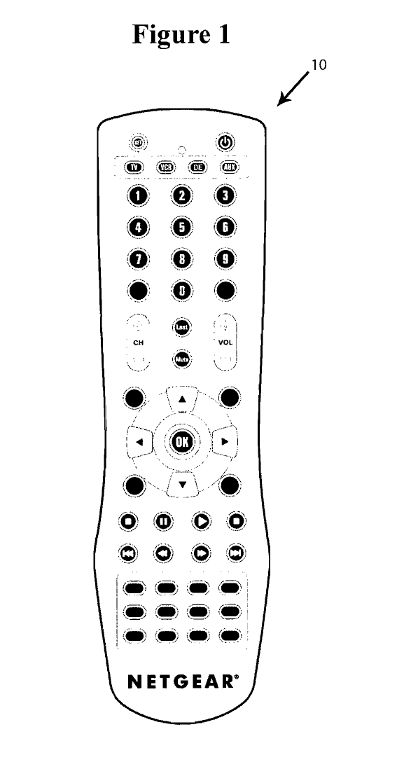

FIG. 2 is a schematic of a remote control apparatus controlling one or more devices; and

FIG. 3 is a front elevation view of a remote control apparatus according to one embodiment.

### DETAILED DESCRIPTION OF ILLUSTRATED EMBODIMENTS

In accordance with one embodiment, a method for incorporating an alphabetic keyboard into a simple remote control device is provided in order to offer full alphanumeric text entry as well as remote control functionality. The remote control keys have a dual use as either a keyboard or a standard remote as described in detail below and in a manner which overcomes the deficiencies of the solutions found in the prior art.

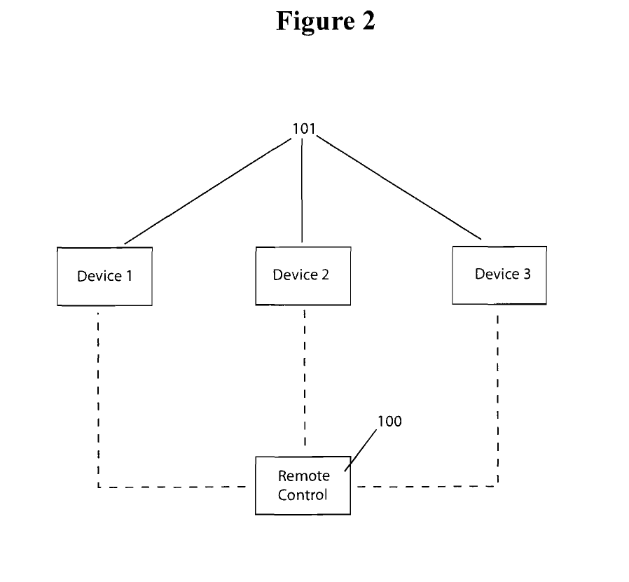

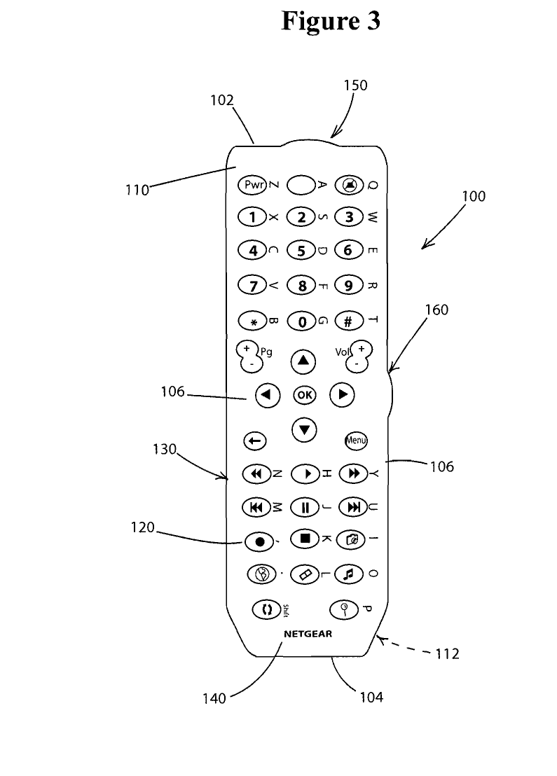

FIGS. 2-3 illustrate a remote control 100 according to one embodiment. FIG. 2 is a schematic showing the remote control 100 being in communication with one or more devices, generally indicated at 101, that are to be controlled with the remote control 100. The devices 101 can be any number of devices, including audio equipment, visual equipment (TV), etc.

As shown in FIG. 3, the remote control 100 is similar to the conventional remote control 10 in that it includes a body having a first end (top) 102, an opposite second end (bottom) 104 and a pair of sides 106. The remote control 100 also has a front face or surface 110 and an opposing rear face or surface 112. Typically, the rear face 112 includes an openable battery compartment for storing batteries to power the remote control 100. The front face 110 includes a plurality of buttons or keys or the like 120 to permit the user to enter desired commands and navigate through different functionality.

In accordance with the illustrated embodiment, the keys 120 are organized so that the keys 120 appear in rows, generally indicated at 130, and columns, generally indicated at 140, simulating the rows and columns of a keyboard. As shown in FIG. 3, the columns 140 extend from the top 102 to bottom 104 and the rows 130 extend from one side 106 to the other side 106. Each key 120 therefore has associated therewith a “horizontal” label and a “vertical” label. In other words, each key 120 has a label which is readable when the remote control 100 is held upright (top end 102 pointing up) and another label which is readable when the remote control 100 is held sideways (one side 106 facing up).

The uniform layout makes the key positions usable in either orientation. Typically and as shown in the illustrated embodiment, the alphabetic keys are arranged in columns so that a standard alphabetic keyboard is formed when the remote control 100 is held sideways. Conversely, when the remote control 100 is held upright (normal vertical orientation), legends for media control, such as channel numbers and shuttle controls, are presented and displayed to the user. FIG. 3 shows these two orientations of the layout and it will be appreciated that if the user wants to use the alphabetic keyboard, the user simply places the keyboard 100 in a horizontal orientation to permit text entry similar to the key arrangement of a standard alphabetic keyboard.

The remote control 100 can incorporate a number of different mechanisms that permit the remote control 100 to determine which orientation the remote control 100 is in and/or which orientation is desired. For example, if the remote control 100 is of a type that communicates via infrared technology, the remote control 100 can have a first IR emitter (transmitter) 150 in a first location and a second IR emitter (transmitter) 160 in a second location. The first and second locations are positioned such that at least one of the emitters 150, 160 is always not blocked by the user's hands in either orientation. In FIG. 3, the first IR emitter 150 is for use when the remote control 100 is in a vertical orientation and the second IR emitter 160 is for use when the remote control 100 is in a horizontal orientation.

The remote control 100 is thus set to emit a different IR code depending upon the state of the remote (i.e., whether the remote control 100 is in the upright orientation or the sideways orientation). Alternatively, the system being controlled can enter a state in which it recognizes the IR codes as one or the other of the sets of keys 120.

The remote control 100 is configured such that the switch from one state (i.e., vertical orientation/media functionality) to the other state (i.e., a horizontal orientation/text entry) can be either triggered automatically or at the direction of the user. For example, the state can be detected automatically by using a tilt sensor in the remote. A tilt sensor is configured to measure the tilt of an object relative to reference planes and in this case, the tilt sensor serves to measure the tilt of the remote control 100. As the user rotates the remote control 100 from the upright state to the sideways state, the remote control 100 tilts, thereby activating the tilt sensor. The remote control 100 thus knows which state it is in and therefore, the proper codes relative to the keys 120 for this orientation are sent. As a result, the remote control 100 switches from one state (media) to the other state (text entry) based on the orientation of the remote control 100.

If the switch of the states of the remote control 100 is at the direction of the user, a switch or button or key or the like can be provided as part of the remote control 100. To change states, the user can simply move the switch or press a key which reassigns the control to media or text entry function. To return back to the original state, the user simply moves the switch back to the original position to restore the original functionality.

In the event and according to one embodiment where the remote control 100 emits different codes in each state, namely, media/text entry states, the device that is controlled by the remote control 100 need not be aware that the remote control 100 has multiple states. This can be advantageous should a separate full size keyboard be a desirable option.

In the event that the remote control 100 is emitting the same codes regardless of its orientation, the device being controlled by the remote control 100 must be informed of the state of the remote control 100 (i.e., vertical or horizontal). If a tilt switch is being used as part of the remote control 100, the actuation of the tilt switch causes the remote control 100 to emit “set horizontal orientation” and “set vertical orientation” codes. If a tilt switch is not use, a user activated key serves the same function, and the user presses a key or toggles a switch when using the remote control 100 in one or the other orientation. The device that is controlled with the remote control 100 then remembers the current state of the remote control 100 and responds to the remote control 100 as if it were emitting separate codes for each orientation.

It will also be appreciated that in another embodiment, the remote control 100 is configured so that it includes “smart” backlighting in that backlighting is only displayed on the legends currently active. In this way, the function of the keys is highlighted differently in each mode. For example, when the media functions correspond to the remote control being in the vertical orientation, then only those legends that are oriented vertically are backlit when the remote control 100 is oriented vertically for use. Conversely, when the remote control 100 is oriented horizontally, only those legends that are horizontally oriented are backlit.

In yet another embodiment, the remote control 100 is configured so that some of the keys emit exchange codes with others so that for example, an arrow directional pad, as shown in FIG. 3, surrounding the “OK” button above would rotate the codes 90 degrees counterclockwise with the right angle emitting the “up” code when in the horizontal orientation.

While the invention has been described in connection with certain embodiments thereof, the invention is capable of being practiced in other forms and using other materials and structures. Accordingly, the invention is defined by the recitations in the claims appended hereto and equivalents thereof.

What is claimed is:

1. A remote control apparatus comprising:
a first transmission means for use when the remote control apparatus is in a horizontal orientation;
a second transmission means for use when the remote control apparatus is in a vertical orientation;
a keypad having a plurality of keys that have a first set of labels for use in the horizontal orientation and a second set of labels for use in the vertical orientation; and
a means for determining whether the remote control is in the horizontal orientation or the vertical orientation, wherein at least some of the keys have a first functionality when in the horizontal orientation and a second functionality when in the vertical orientation.

2. The remote control apparatus of claim 1, wherein each of the first and second transmission means comprises a separate infrared (IR) LED.

3. The remote control apparatus of claim 1, wherein the first and second transmission means comprises radio frequency (RF) using a single radio for transmission in both the vertical and horizontal orientations.

4. The remote control apparatus of claim 1, wherein the means for determining whether the remote control is in the horizontal or vertical orientations comprises a tilt sensor.

5. The remote control apparatus of claim 1, wherein the means for determining whether the remote control is in the horizontal or vertical orientations comprises a switch that is movable between a first position corresponding to the horizontal orientation and a second position corresponding to the vertical orientation.

6. The remote control apparatus of claim 1, wherein the means for determining whether the remote control is in the horizontal or vertical orientations utilizes one key in the keypad to indicate change of orientation.

7. The remote control apparatus of claim 1, further comprising a microprocessor coupled to the first and second transmission means, the keypad, and the means for determining whether the remote control is in the horizontal or vertical orientations, wherein the microprocessor transmits different key codes for at least one key of the keypad depending upon on the means for determining whether remote control is in the horizontal or vertical orientations.

8. The remote control apparatus of claim 1, wherein the means for determining whether the remote control is in the horizontal or vertical orientations causes the remote control apparatus to transmit an orientation change or indicator to a device that is being controlled by the remote control apparatus.

9. The remote control apparatus of claim 1, wherein a device that is being controlled by the remote control apparatus responds to the same key codes differently depending upon whether the remote control is in the horizontal orientation or the vertical orientation.

10. The remote control apparatus of claim 1, wherein the first set of labels comprises alphabetic labels to permit the user to enter text with the remote control apparatus and the second set of labels comprises media control labels to permit the user to navigate through different media control functionality.

11. A remote control apparatus comprising:
a keypad having a plurality of keys that have a first set of labels for use when the remote control is in a horizontal orientation and a second set of labels for use when the remote control is in a vertical orientation; and
a means for determining whether the remote control is in the horizontal orientation or the vertical orientation, wherein at least some of the keys have a dual use in that the first label of one key corresponds to a first functionality realized by actuation of the key when the remote control is operating in a horizontal orientation mode and the second label for the same key corresponds to a second functionality realized by actuation of the key when the remote control is operating in a vertical orientation mode.

12. The remote control apparatus of claim 11, further comprising:
a first transmitter that operates when the remote control apparatus is in the horizontal orientation; and
a second transmitter that operates when the remote control apparatus is in the vertical orientation.

13. The remote control apparatus of claim 11, wherein the first set of labels is readable when the remote control apparatus is in the horizontal orientation and includes alphabetic labels to permit the user to enter text with the remote control apparatus and the second set of labels is readable when the remote control apparatus is in the vertical orientation and includes media control labels to permit the user to navigate through different media control functionality.

14. The remote control apparatus of claim 12, wherein each of the first and second transmitters comprises a separate infrared (IR) LED.

15. The remote control apparatus of claim 12, wherein the first and second transmitters comprises radio frequency (RF) using the same radio for transmission in both the vertical and horizontal orientations.

16. The remote control apparatus of claim 11, wherein the remote control apparatus operates in a text entry state in the horizontal orientation and in a media control state in the vertical orientation and emits different codes in each of the two states.

17. The remote control apparatus of claim 11, wherein the remote control apparatus operates in a text entry state in the horizontal orientation and in a media control state in the vertical orientation and emits the same codes regardless of its orientation and a device that is being controlled by the remote control apparatus is informed about the orientation of the remote control apparatus.

18. The remote control apparatus of claim 11, wherein the means for determining whether remote control is in the horizontal or vertical orientations comprises a tilt sensor.

19. The remote control apparatus of claim 11, wherein the means for determining whether remote control is in the horizontal or vertical orientations comprises a switch that is movable between a first position corresponding to the horizontal orientation and a second position corresponding to the vertical orientation.

20. The remote control apparatus of claim 11, wherein the means for determining whether remote control is in the horizontal or vertical orientations utilizes one key in the keypad to indicate change of orientation.

21. The remote control apparatus of claim 11, further including a backlighting feature that is configured to only light the set of labels that is currently active such that at least some keys are lighted differently when the remote control apparatus is in the horizontal orientation and the vertical orientation.

22. A method for incorporating an alphabetic keyboard into a remote control device in order to provide full alphanumeric text entry as well as remote control functionality comprising the steps of:
assigning a first set of labels to keys that are part of a keypad of the remote control apparatus, the first set of labels for use when the remote control apparatus is in a horizontal orientation;
assigning a second set of labels to the keys of the keypad, the second set of labels for use when the remote control apparatus is in a vertical orientation;
determining whether the remote control apparatus is in the horizontal orientation or the vertical orientation;
using a first transmitter when the remote control apparatus is in the horizontal orientation to send information to a device to be controlled by the remote control device, the information corresponding to the first labels of the keys; and
using a second transmitter when the remote control apparatus is in the vertical orientation to send information to the device to be controlled that corresponds to the second labels of the keys, whereby at least some of the keys have a dual use in that the same key has one function in the horizontal orientation and another function in the vertical orientation.

23. The method of claim 22, wherein the step of determining whether the remote control apparatus is in the horizontal orientation or the vertical orientation comprises the step of using a tilt sensor to detect movement and orientation of the remote control apparatus.

24. The method of claim 22, wherein the step of determining whether the remote control apparatus is in the horizontal orientation or the vertical orientation comprises the step of determining the position of a two position switch that is part of the remote control apparatus, one position corresponding to the horizontal orientation, the other position corresponding to the vertical position.

25. The method of claim 22, wherein the remote control is configured so that at least some of the keys emit different codes when the remote control apparatus is in the horizontal position compared to when it is in the vertical position.
